(19) United States
(12) Patent Application Publication
(10) Pub. No.: US 2016/0337512 A1
(43) Pub. Date: Nov. 17, 2016

(54) DETECTING TRANSMISSION LINE IMPAIRMENTS USING REFLECTOMETRY

(71) Applicant: Ikanos Communications, Inc., Fremont, CA (US)

(72) Inventor: Raghunath Kalavai, Bedminster, NJ (US)

(21) Appl. No.: 15/151,373

(22) Filed: May 10, 2016

Related U.S. Application Data
(60) Provisional application No. 62/159,636, filed on May 11, 2015.

(51) Int. Cl. H04M 3/30

(52) U.S. Cl. CPC H04M 3/30

(57) ABSTRACT

Methods, systems, and devices are described for wired communication. In one aspect, a method relates to detecting cable impairments with reflectometry. The method includes transmitting a test signal and receiving one or more reflected signals in response to the test signal. The method also includes applying a first asymmetric windowing function to the one or more reflected signals to generate frequency domain data. Additionally, the method includes transforming the frequency domain data from a frequency-domain representation to a time-domain representation to generate a time domain reflectometry (TDR) signal. The method can detect and locate a bridge tap, line cut, and/or termination condition on the transmission line.

### CROSS REFERENCES

The present application for patent claims priority to U.S. Provisional Patent Application No. 62/159,636 by Kalavai, entitled “High-Resolution Detection of Bridgetap, Line-Cut and Termination Using SELT,” filed May 11, 2015, assigned to the assignee hereof, and expressly incorporated by reference herein.

### BACKGROUND

1. Field of the Disclosure

The present disclosure relates generally to data communications, and more particularly to techniques for detecting transmission line impairments using reflectometry.

2. Description of Related Art

In wired communications such as digital subscriber line (DSL) systems, coaxial cable systems, etc., loop diagnostics are often based on the analysis of single-ended loop (or line) testing (SELT) processes. Typically, a SELT analysis tool will detect impairments such as bridge taps, line cuts, or bad splices. For example, in single-ended line tests (see, e.g., ITU-T G.996.2, SERIES G: TRANSMISSION SYSTEMS AND MEDIA, DIGITAL SYSTEMS AND NETWORKS, Digital sections and digital line system—Access networks, Line Testing for Digital Subscriber lines (DSL), May 2009), a known signal is sent over the loop and the reflected signal is analyzed to determine loop characteristics and any impairments present on the transmission line. However, problems remain in accurately detecting and locating impairments using SELT processes, particularly when multiple impairments exist on the transmission line.

### SUMMARY

The present description discloses techniques for detecting impairments in a transmission line, such as a Digital Subscriber Line (DSL), using time domain reflectometry (TDR). According to these techniques, a test device (e.g., a device or component in communication or integrated with customer premise equipment (CPE) or central office (CO) equipment) operatively coupled to one end of the transmission line (e.g., a DSL line, coaxial cable, or powerline) transmits a test signal and receives one or more reflected signals over the transmission line. The test device applies a windowing function to the one or more reflected signals to generate frequency domain data. The windowing function is an asymmetric windowing function, and different asymmetric windowing functions are used for different types of impairments to be detected and located (e.g., a first asymmetric windowing function is used for detecting a bridge tap, a second asymmetric windowing function is used for detecting a line cut, etc.). The test device then transforms the frequency domain data from a frequency-domain representation to a time-domain representation to generate a TDR signal.

The test device then applies a compensating time domain windowing function to the TDR signal. In some cases, the test device applies a smoothing filter to the TDR signal. The test device determines whether or not an impairment exists on the transmission line based at least in part on a level of a peak of the TDR signal. In this regard, the test device can detect whether the peak is indicative of a legitimate impairment or merely a spurious spike to be ignored in the impairment detection process.

A method for detecting one or more impairments in a transmission line is described, The method includes transmitting a test signal, receiving one or more reflected signals in response to the test signal, applying a first asymmetric windowing function to the one or more reflected signals to generate frequency domain data, and transforming the frequency domain data from a frequency-domain representation to a time-domain representation to generate a time domain reflectometry (TDR) signal.

A device for detecting one or more impairments on a transmission line is described. The device includes a signal transmitter to transmit a test signal, a signal capture manager to receive one or more reflected signals in response to the transmitted test signal and to convert the one or more reflected signals into frequency response data, a frequency domain windowing manager to apply a first asymmetric windowing function to the frequency response data to generate frequency domain data, and an inverse fast Fourier transform (IFFT) manager to transform the frequency domain data to a TDR signal.

A further device for detecting one or more impairments on a transmission line is described. The device includes means for transmitting a test signal, means for receiving one or more reflected signals in response to the test signal, means for applying a first asymmetric windowing function to the one or more reflected signals to generate frequency domain data, and means for transforming the frequency domain data from a frequency-domain representation to a time-domain representation to generate a TDR signal.

A non-transitory computer-readable medium comprising computer-readable code is described. The computer-readable code, when executed, causes a device to transmit a test signal, receive one or more reflected signals in response to the test signal, apply a first asymmetric windowing function to the one or more reflected signals to generate frequency domain data, and transform the frequency domain data from a frequency-domain representation to a time-domain representation to generate a TDR signal.

In some examples of the method, devices, or non-transitory computer-readable medium described above, the first asymmetric windowing function comprises a low frequency roll-off rate that is different from a high frequency roll-off rate. Additionally or alternatively, in some examples, a window shape of the first asymmetric windowing function is based at least in part an impairment detection type, the impairment detection type being selected from one member of the group consisting of: a bridge tap, a line cut, and a line card termination.

Some examples of the method, devices, or non-transitory computer-readable medium described above may further include applying a second asymmetric windowing function to the one or more reflected signals to generate additional frequency domain data, the second asymmetric windowing function having a different widow shape than the first asymmetric windowing function.

Some examples of the method, devices, or non-transitory computer-readable medium described above may further include applying a compensating time domain windowing function to the TDR signal. In some examples, the compensating time domain windowing function is based at least in part on a frequency-dependent attenuation constant associated with the transmission line.

Some examples of the method, devices, or non-transitory computer-readable medium described above may further include applying a smoothing filter to one member of the group consisting of: the frequency domain data, and the TDR signal

In some examples of the method, devices, or non-transitory computer-readable medium described above, the transforming the frequency domain data from the frequency-domain representation to the time-domain representation include zero-padding the frequency domain data, and performing an inverse fast Fourier transform (IFFT) function on the zero-padded frequency domain data to generate the TDR signal.

Some examples of the method, devices, or non-transitory computer-readable medium described above may further include determining an impairment on the transmission line based at least in part on a level of a peak of the TDR signal. Additionally or alternatively, some examples may further include determining an impairment on the transmission line based at least in part on a ratio of two or more peak levels of the TDR signal. Additionally or alternatively, some examples may further include determining an impairment on the transmission line based at least in part on a distance between two or more peaks of the TDR signal.

Some examples of the method, devices, or non-transitory computer-readable medium described above may further include performing, prior to transmitting the test signal, a plurality of Single Ended Line Test (SELT) captures for the transmission line. Additionally or alternatively, some examples may further include determining, based at least in part on an output of the plurality of SELT captures, an inconsistency associated with time delay variations in a transceiver chain. Additionally or alternatively, some examples may further include determining, based at least in part on an output of the plurality of SELT captures, that transceiver transfer function characteristics are not flat, and adjusting, based at least in part on the determining that transceiver transfer function characteristics are not flat, a parameter setting associated with an analog/digital component block.

Some examples of the method, devices, or non-transitory computer-readable medium described above may further include removing a near-end reflection signal component from the received one or more reflected signals.

Further scope of the applicability of the described systems, methods, devices, or computer-readable media will become apparent from the following detailed description, claims, and drawings. The detailed description and specific examples are given by way of illustration only, and various changes and modifications within the scope of the description will become apparent to those skilled in the art.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an example of a DSL system in which techniques for detecting transmission line impairments using reflectometry can be implemented in accordance with various aspects of the present disclosure;

FIG. 2 is a diagram illustrating an example of a bridge tap and a line cut on a transmission line in accordance with various aspects of the present disclosure;

FIG. 3A is a block diagram illustrating an example of a test device that supports detecting transmission line impairments in accordance with various aspects of the present disclosure;

FIG. 3B is a block diagram illustrating an example of a process for detecting a bridge tap on a transmission line in accordance with various aspects of the present disclosure;

FIG. 3C is a block diagram illustrating an example of a process for detecting a line cut on a transmission line in accordance with various aspects of the present disclosure;

FIGS. 4A and 4B show block diagrams of examples of test devices that support detecting transmission line impairments in accordance with various aspects of the present disclosure;

FIG. 5 shows a flow chart that illustrates an example of a method for detecting transmission line impairments in accordance with various aspects of the present disclosure;

FIG. 6 is a plot illustrating examples of different frequency domain windows used for windowing functions in accordance with various aspects of the present disclosure;

FIG. 7 is a plot illustrating examples of time domain representations of different frequency domain windows used for windowing functions in accordance with various aspects of the present disclosure;

FIG. 8 is a plot illustrating examples of the effects of different windows used for windowing functions in accordance with various aspects of the present disclosure; and

FIG. 9 is a plot illustrating examples of a detected and located transmission line impairment in accordance with various aspects of the present disclosure.

### DETAILED DESCRIPTION

According to aspects of the present disclosure, a test device for detecting impairments on a Digital Subscriber Line (DSL) using time domain reflectometry (TDR) techniques enables accurate detection and location identification of impairments on the DSL line, including detection and location identification of multiple impairment on the same DSL line (e.g., identifying and locating a bridge tap, as well as identifying and locating a line cut on the same DSL line even in the presence of the bridge tap). Accurate detection and location of bridge taps, line cuts, line card terminations (or termination conditions), and other impairments are important because these impairments can reduce the achievable data bandwidth on the DSL line. For example, a bridge tap is an extraneous dangling cable connected to the main line as a “T” or a branch that causes an impedance mismatch and signal reflections, which may lead to a loss in bandwidth capacity on the DSL line.

The test device utilizes various techniques to distinguish legitimate peaks indicating DSL line impairments from spurious spikes in the signal analysis process. For example, a version of the DSL systems standard (G.Fast) offers data rate up to 1 Gbps over twisted pairs, and the detection of bridge taps and other impairments to the DSL line is therefore performed over a full frequency band of 2.2 MHz, 8.5 MHz, 12 MHz, and/or 17.6 MHz with a higher accuracy and longer range using these various techniques (at times applied individually and at other times applied in combination). In a first operation, baselining and calibration processes are performed by the test device. These baselining and calibration processes are optionally performed before the test device transmits the test signal to be used in detecting and locating impairments on the DSL line. The test device receives one or more reflected signals in response to the transmitted test signal. These reflected signals are analyzed in the frequency domain and used to generate frequency response data (e.g., S₁₁ data or uncalibrated echo response (UER) data).

Next, the test device performs frequency domain windowing functions to the frequency response data in which customized asynchronous windows based at least in part on Tukey windows are utilized. As such, frequency domain data is generated from the frequency response data for further processing and analysis by the test device. In some examples, the roll-off of a customized asynchronous window at lower frequencies is sharper than the roll-off at higher frequencies. The customized asynchronous windows are determined (e.g., using empirical data and test results) to best enhance the signal signature of a bridge tap, line cut, line card termination, etc., and different customized asynchronous windows are used for detecting different impairments. In some implementations, different custom windows are used for different bandwidths.

The test device applies an inverse fast Fourier transform (IFFT) to this asynchronously-windowed frequency domain data to generate a TDR signal. In some implementations, a 32K IFFT is used in the frequency domain to time domain transform process. Other sizes of IFFTs as well as other techniques for frequency domain to time domain transform techniques can be used, however, to generate the TDR signal. The output of the IFFT is processed through a time domain windowing function to offset leveling due to propagation attenuation (i.e., the time domain windowing function compensates for attenuation of the one or more reflected signals). After the time domain windowing function is performed, smoothing of the time domain windowed TDR signal is optionally performed. In some cases, the reflected signals are analyzed and processed multiple times to determine whether multiple impairments are present on the DSL line.

The test device then processes the time domain windowed TDR signal to detect the levels of the various peaks of this TDR signal and determine if these levels are indicative of an impairment on the DSL line. Legitimate peaks that properly identify impairments are selected by thresholding based at least in part on predetermined levels associated with certain anticipated impairments (e.g., levels as determined using empirical data and test results). In some cases, the test device can detect and locate a bridge tap based at least in part on a ratio between two adjacent peaks and a distance between the two adjacent peaks.

Accordingly, automatic and accurate diagnostics using the test device can improve the operational efficiency for service providers with very little overhead. In this regard, the data collected can also be a valuable resource for analyzing and improving service for DSL deployments and service offerings. Moreover, while the test device is described in the context of a DSL system, the techniques described herein can be readily used with respect to detection and location of impairments associated with other communication systems and corresponding transmission lines, such as, but not limited, to coaxial cables and powerlines.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

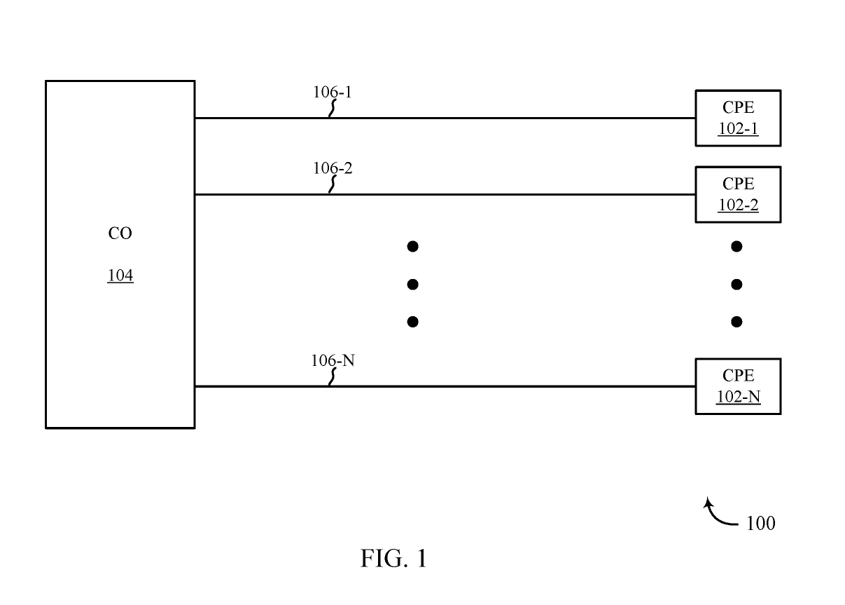

Referring first to FIG. 1, a block diagram illustrates an example of a DSL system 100 in which techniques for detecting transmission line impairments can be implemented in accordance with various aspects of the present disclosure. The DSL system 100 includes a plurality of N customer premise equipment (CPE) transceivers 102-1 to 102-N that are operatively coupled to a central office (CO) 104 via respective loops 106-1 to 106-N. In one example, DSL system 100 can be a DSL system operating according to very-high-bit-rate digital subscriber line 2 (VDSL2) technology, in which some or all of CPE transceivers 102-1 to 102-N are configured as a vectoring group by CO 104.

In some examples, loop diagnostics for DSL system 100 are based at least in part on analysis of single-ended loop (or line) testing (SELT) processes and data therefrom. For example, CPE transceiver 102-1 can perform diagnostics to characterize loop 106-1 using SELT signals transmitted by CPE 102-1 on loop 106-1 and reflected back to CPE transceiver 102-1. Specifically, when DSL system 100 is operating according to VDSL2, a conventional SELT performed by CPE transceiver 102-1 can include continuously transmitting symbols (e.g., modulated REVERB symbols) during each VDSL2 symbol period for a time period of approximately five seconds to two minutes, and measuring the signal reflections (i.e., obtaining S₁₁ data or UER data) from loop 106-1. Some or all of the other CPE transceivers 102-2 to 102-N can be operating in showtime mode using the same symbol periods while CPE transceiver 102-1 performs the SELT processes.

The CPE transceivers 102-1 to 102-N of DSL system 100 operating according to VDSL2 are assigned certain frequency bands in which the CPE transceivers 102-1 to 102-N are permitted to transmit upstream signals according to a prescribed DSL system frequency band plan. Additionally, equipment in CO 104 such as a DSL access multiplexer (DSLAM) can be assigned certain frequency bands in which the equipment in the CO 104 is permitted to transmit downstream signals according to the prescribed DSL system frequency band plan.

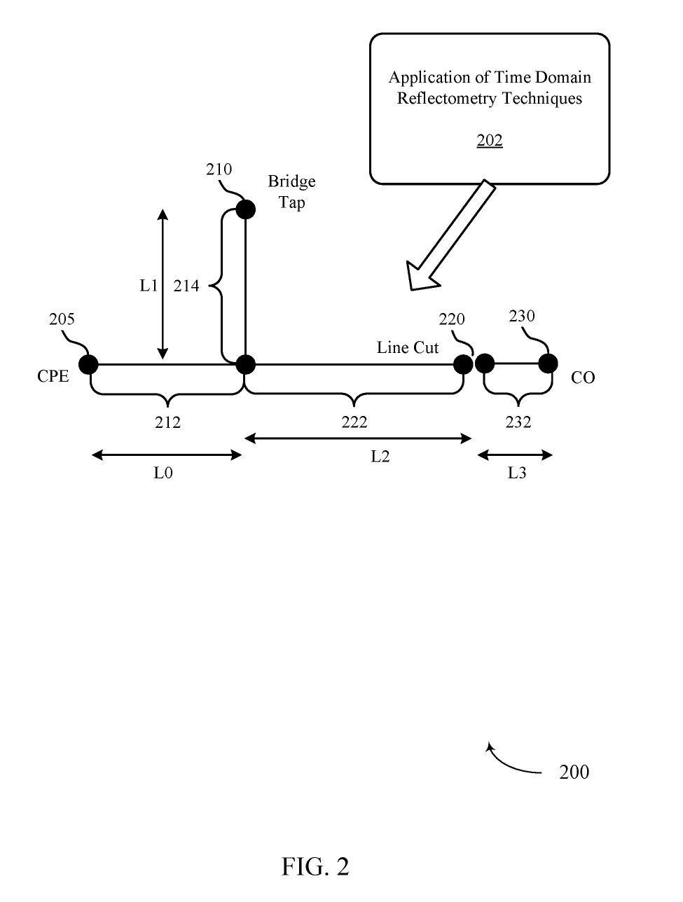

FIG. 2 is a diagram of an example of an impairment scenario 200 in which a bridge tap 210 and a line cut 220 on a DSL line (e.g., loop 106-1 of FIG. 1) in accordance with various aspects of the present disclosure. Application of TDR techniques 202 can be performed by a test device from a perspective of CPE 205 or CO 230.

Bridge tap 210 can be an extraneous segment of cable leftover from a prior configuration of the twisted pair cable facilities of a service provider. Service providers typically do not have a historical record of bridge taps occurring in the twisted pair cable facilities as such impairments typically have a lesser effect on plain old telephone service (POTS), which historically predominated the use of twisted pair cable facilities, than DSL service. Proper detection, location, and length estimation of bridge tap 210 can be used for facilitating efficient dispatch of a technician and removal of bridge tap 210 from the DSL line.

Breaks or line cuts are also common problems for DSL systems and lead to loss of connectivity and an extensive investigation to remedy the problem. A line cut 220 can relate to two types of twisted pair impairments: an electrical open condition or an electrical short condition. Thus, proper detection and location of a line cut 220 can be used for facilitating efficient dispatch of a technician and corrective measures for line cut 220. Additionally, analysis of the DSL line to determine termination condition such as whether a line card termination is present at the CO 230 end or CPE 205 end of the DSL line can be performed by application of TDR techniques 202 described herein.

In the impairment scenario 200 diagrammed in FIG. 2, bridge tap 210 is a distance 212 of length L0 from CPE 205. Bridge tap 210 extends a distance 214 of length L1. Line cut 220 is distance 212 of length L0 and distance 222 of length L2 from CPE 205. From the CO perspective, line cut 220 is distance 232 of length L3 from the CO 230. Thus, the main loop length of the DSL line is distance 212 of length L0, distance 222 of length L2 and distance 232 of length L3.

By applying TDR techniques 202 to the DSL line from CPE 205, bridge tap 210 will be represented by two significant peaks in the TDR signal: a negative peak at a starting location (length L0) of bridge tap 210, and a positive peak at an ending location (length L0 plus length L1) of bridge tap 210. Upon determining a location of bridge tap 210 based at least in part on time-domain samples associated with the TDR signal, a mapping curve is developed between the time-domain samples and a unit distance measurement (e.g., feet). Thus, test device detects bridge tap 210 and estimates that bridge tap 210 is connected to the DSL line at length L0 from CPE 205 and that bridge tap 210 extends length L1 from the connection point of the bridge tap 210. TDR techniques 202 applied to the DSL line will also detect peaks of various levels associated with line cut 220 and line card terminations at the CO 230 or the CPE 205.

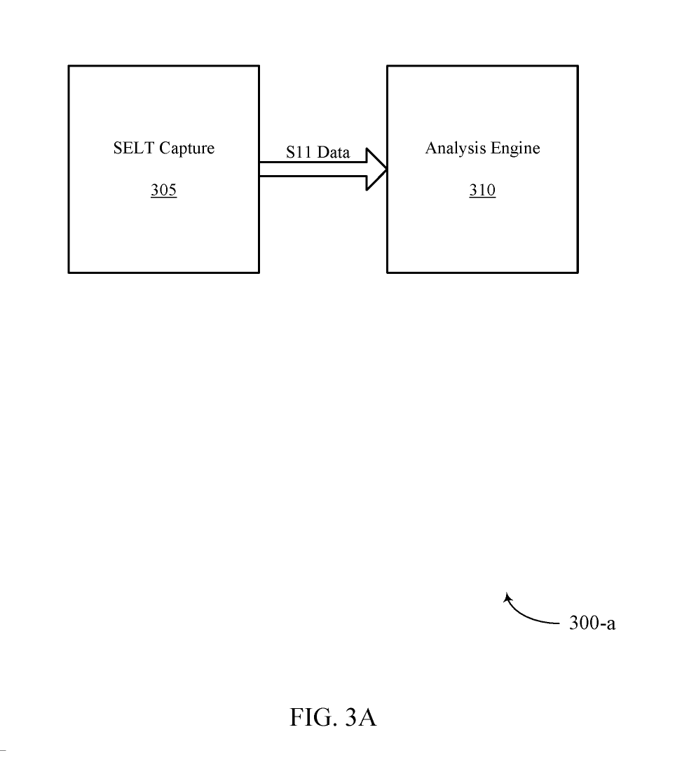

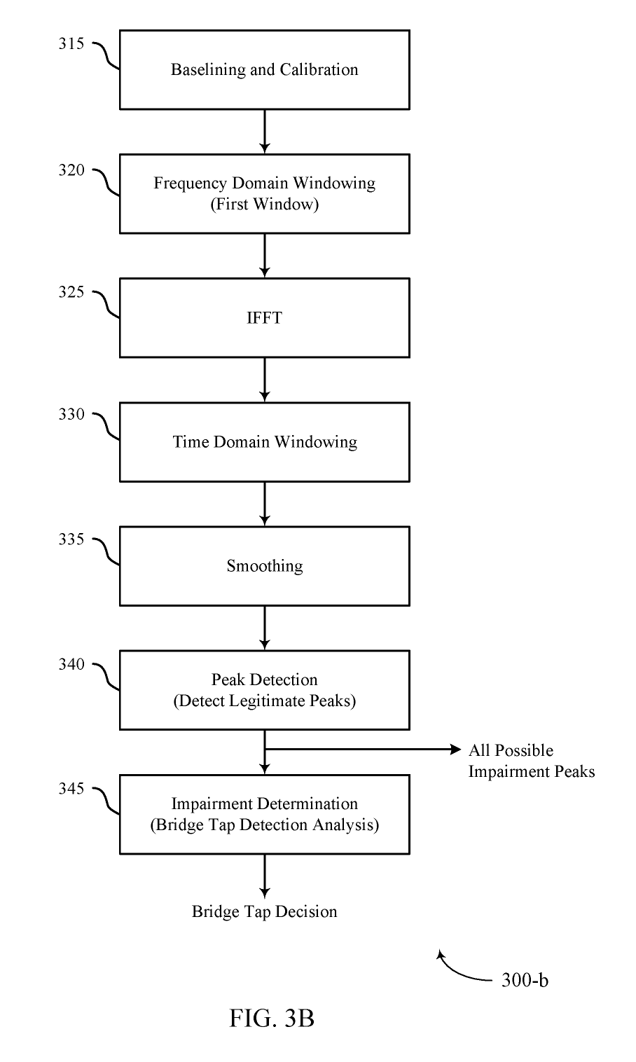

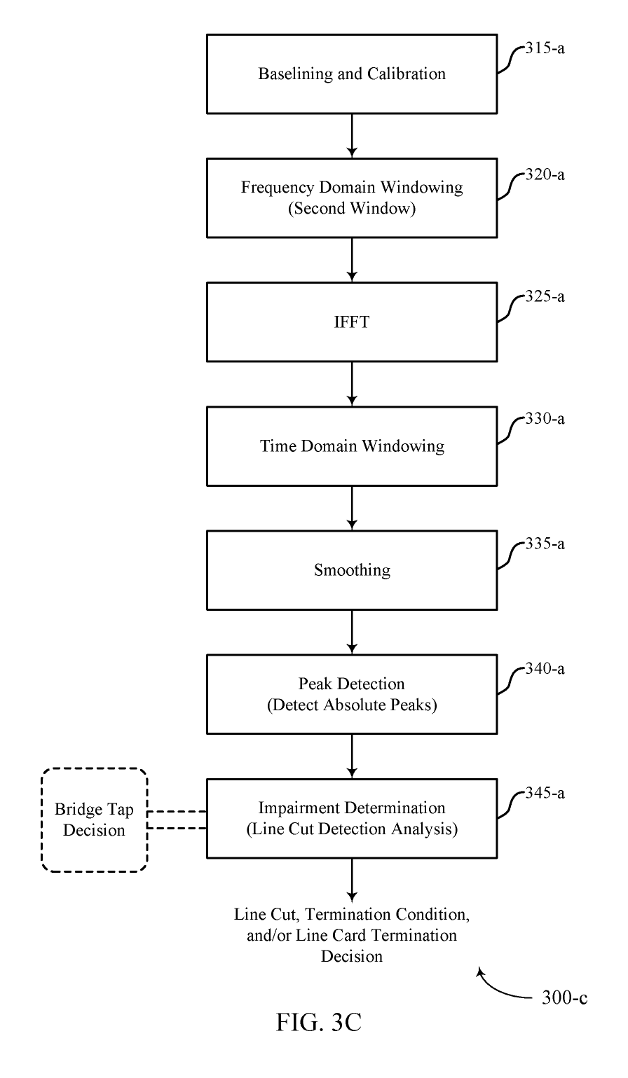

FIG. 3A shows a block diagram of an example of a test device 300-a that supports detecting transmission line impairments. Test device 300-a can be utilized in the DSL system 100 to test a DSL line (e.g., loop 106-1) with respect to FIG. 1 and for applying TDR techniques 202 to impairment scenario 200 described with respect to FIG. 2. Aspects of the test device 300-a can be implemented in a remote testing system (e.g., integrated with a DSL modem or with a DSLAM).

Test device 300-a includes a SELT capture block 305 and an analysis engine block 310. Test device 300-a detects impairments by analyzing the one port scattering parameter S₁₁(f). Test device 300-a transmits a test signal and a reflected signal is received and measured by SELT capture block 305. The test signal can be an orthogonal frequency-division multiplexing (OFDM) symbol of pseudo-random data that is repeated for several symbol periods. SELT signal S₁₁ can be determined as follows:

$${S}_{11} ( f ) = \frac{b ( f )}{a ( f )}$$

where b(f) is the reflected signal (e.g., received by SELT capture block 305 of test device 300-a in response to the transmitted test signal) and a is the transmitted (or incident) test signal.

A portion of the transmitted test signal is reflected by the transmission line impairments, and the reflection characteristics form the signature of the impairment. The reflected signal, b(f), is averaged to remove or reduce any noise or other unwanted signal artifacts. In some cases, the test device 300-a may perform SELT operations in an offline mode with respect to the DSL service (e.g., before the DSL modem is connected with the DSLAM via the DSL line). In this regard, SELT operation may also be performed in a line qualification procedure, which is typically performed prior to installation of the CPE to determine the feasibility and estimated performance of the DSL line.

Analysis engine block 310 of test device 300-a receives the SELT signal S₁₁ (e.g., frequency response data) from SELT capture block 305 and performs frequency domain reflectometry techniques with respect to the SELT signal S₁₁ to generate frequency domain data. The frequency domain data is then transformed from a frequency domain representation to a time domain representation to generate a TDR signal. Analysis engine block 310 may further process the TDR signal and determine whether one or more transmission line impairments are present on the DSL line.

FIG. 3B shows a block diagram of an example of a test device 300-b that supports detecting transmission line impairments. Test device 300-b can be utilized in the DSL system 100 to test a DSL line (e.g., loop 106-1) with respect to FIG. 1 and for applying TDR techniques 202 to impairment scenario 200 described with respect to FIG. 2. Additionally, test device 300-b can include aspects of test device 300-a described with respect to FIG. 3A.

Distortion or error in a SELT capture process can corrupt the SELT signal S₁₁. To mitigate distortion or error, test device 300-b includes a baselining and calibration block 315. Baselining and calibration block 315 performs one or more baselining tests such as, but not limited to, a capture repeatability test, transceiver processing chain consistency test, and signal level consistency test. In the capture repeatability test, SELT data is repeatedly captured with power cycling and compared. Repeated SELT captures with a same loop should yield similar SELT data. As such, the capture repeatability test ensures that no inconsistencies exist in the transceiver chain that can corrupt the SELT data when the test device 300-b begins testing for transmission line impairments. For example, inconsistencies in SELT data will result when a control processor clock in not synchronous with hardware clocks of the transceiver chain.

The transceiver processing chain consistency test ensures that the processing chain associated with the transmit and receive functions of the DSL modem does not introduce any modification of the SELT data. For example, the transmit and receive transfer function characteristics are checked using a spectrum analyzer and signal generator to ensure that the transfer function characteristics are substantially flat. If the transceiver processing chain consistency test fails, the inconsistencies can be corrected by adjusting parameter settings associated with an analog/digital circuit section or component.

The signal level consistency test determines whether the signal gain through the transceiver chain is a fixed gain during the SELT capture process. For example, automatic gain control (AGC) settings should be constant or factored in some manner during the SELT capture process.

After performing baselining tests, baselining and calibration block 315 performs one or more calibration functions. For example, a near-end reflection exists at a point where the DSL modem connects to the DSL line. This near-end reflection results from an impedance mismatch existing between the source impedance and the DSL line impedance. The near-end reflection can corrupt the SELT capture process (e.g., causing false alarms or missed detections associated with the impairment signatures of weaker reflections).

In some examples, a measured near-end reflection removal procedure is performed. The near-end reflection signal component is subtracted out of the SELT captures based on a near-end reflection signature determined from an impairment-free transmission line having matched impedance that is similar to the DSL line to be tested. The measured SELT value associated with the impairment-free transmission line is stored as the near-end reflection signal component and then subtracted from the SELT signal S₁₁.

In other calibration examples, a base impedance transformation is performed in which the measured S₁₁ data is transformed to match the impedance of the DSL line to be tested. In yet another calibration example, the near-end reflection signal component is achieved by a short, open, terminated calibration procedure. In this procedure, three measurements of the SELT signal S₁₁ are performed with the DSL modem shorted, opened, and matched with a 100 ohm termination.

Test device 300-b also includes a frequency domain windowing block 320. Analogous to spectral estimation of time domain data for enhancing detection of spectral components and minimizing or reducing spectral leakage, frequency domain windowing block 320 applies an asynchronous windowing function to the SELT signal S₁₁ (e.g., received frequency response data) to generate frequency domain data for converting into the time domain and performing further analysis thereon. Applying the asynchronous windowing function to the SELT signal S₁₁ enhances the signatures of transmission line impairments. The asynchronous windowing function includes a plurality of asynchronous windows that are customized to enhance the frequency signature of a particular impairment to be tested on the DSL line. For example, frequency domain windowing block 320 applies an asynchronous windowing function with a first asynchronous window when transmitting a SELT signal S₁₁ to generate frequency domain data for detecting a bridge tap. However, the frequency domain windowing block 320 applies an asynchronous windowing function with a second asynchronous window that is different from the first asynchronous window when transmitting a SELT signal S₁₁ to generate frequency domain data for detecting a line cut.

Additionally or alternatively, the plurality of asynchronous windows is customized for a particular bandwidth of the transmitted test signal (e.g., 2.2 MHz, 8 MHz, 12 MHz, 17.6 MHz, etc.). For example, frequency domain windowing block 320 applies an asynchronous windowing function with a first asynchronous window when transmitting a SELT signal S₁₁ at 8.5 MHz to generate frequency domain data for detecting a bridge tap. However, the frequency domain windowing block 320 applies an asynchronous windowing function with a second asynchronous window that is different from the first asynchronous window when transmitting a SELT signal S₁₁ at 17.5 MHz to generate frequency domain data for detecting a bridge tap.

Test device 300-b also includes an IFFT block 325. The IFFT block 325 transforms the frequency domain data to a TDR signal. The IFFT block 325 can use a 32K IFFT function even when a number of samples associated with the frequency response data (and the frequency-domain altered frequency domain data) is less than 4K and the base FFT size according to VDSL2 standards is based on a 4K FFT. Thus, location resolution and detection of signal peaks of the TDR signal are improved by interpolating the frequency domain data during the frequency domain to time domain transform process. The 32K IFFT size can be selected to obtain resolutions significantly higher than a smallest length of interest. An IFFT based on 16-bit precision and may be determined to be insufficient in some of the loop impairment cases. Thus, in some cases, the IFFT function is modified to provide 32-bit accuracy with 64-bit accumulation. This modified IFFT function enables the TDR signal to be more accurate and maintain the integrity of the peaks in the TDR signal.

Test device 300-b also includes a time domain windowing block 330. The output of the IFFT block 325 is processed through a time domain windowing function to offset leveling due to propagation attenuation (the time domain windowing function compensates for attenuation of the one or more reflected signals). The offset leveling associated with the time domain windowing function applied to a TDR signal is based at least in part on a type of transmission line impairment to be detected.

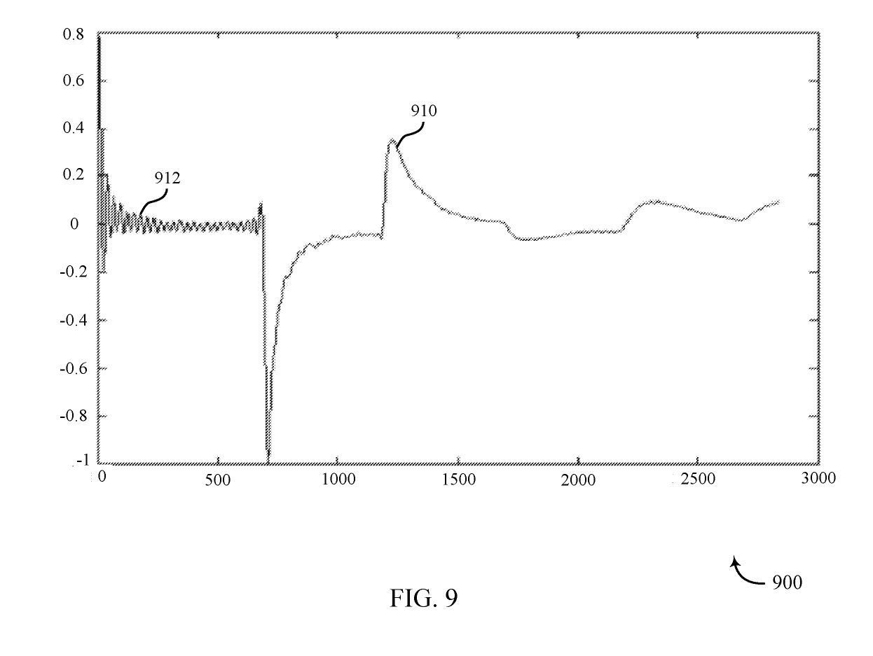

After the time domain windowing function is performed, smoothing of the time domain windowed TDR signal is optionally performed by smoothing block 335. In some cases, a moving average (e.g., a simple moving average) filter is used to smooth the TDR signal. Test device 300-b also includes a peak detection block 340. The thresholds associated with levels for determining legitimate peaks from spurious spikes may be selected based on lab testing or information regarding previously measured peaks. In some cases, the threshold level is based on the lowest peak level that is obtained due to the presence of a particular transmission line impairment (e.g., a bridge tap) for a given distance. A signature of a bridge tap typically will include two significant peaks in the TDR signal: one negative peak at the location of the bridge tap (e.g., at length L0 in impairment scenario 200 diagrammed in FIG. 2), and one positive peak at the end of bridge tap (e.g., at length L0+L1 in the impairment scenario 200 diagrammed in FIG. 2). An example of the signature of a bridge tap is also provided in FIG. 9.

In some cases, several spurious positive and negative spikes will appear in the TDR signal even in the absence of a bridge tap or other transmission line impairment. These spurious spikes can appear in the TDR signal due to the non-ideal characteristics of the transceiver chain. Additionally, peaks associated with the presence of other transmission line impairments such as, but not limited to, a line cut, line card termination, bad splice, flat cable, micro filter, and corrosion, can appear on the TDR signal. It is to be understood that peaks typically appear as a pairs of positive and negative peaks due to the propagation characteristics of the transmission line. Thus, in some impairment scenarios, a pair of negative and positive peaks does not positively identify a bridge tap.

An impairment detection block 345 of test device 300-b qualifies the pair of negative and positive peaks to determine the presence of a bridge tap. In some cases, this qualification is based at least in part on a ratio of the peak levels and the distance between them. A location of a bridge tap is determined based at least in part on time domain samples of the TDR signal. A mapping curve is developed corresponding to the time domain samples and a distance in feet. The impairment detection block 345 can then determine a location and length of a bridge tap detected on the transmission line. In some cases, the reflected signals are analyzed and processed multiple times to determine whether multiple impairments are present on the DSL line.

FIG. 3C shows a block diagram of an example of a test device 300-c that supports detecting transmission line impairments. Test device 300-c can be utilized in the DSL system 100 to test a DSL line (e.g., loop 106-1) with respect to FIG. 1 and for applying TDR techniques 202 to impairment scenario 200 described with respect to FIG. 2. Additionally, test device 300-c can include aspects of test devices 300-a, 300-b described with respect to FIGS. 3A and 3B.

Test device 300-c includes a baselining and calibration block 315-a, frequency domain windowing block 320-a, IFFT block 325-a, time domain windowing block 330-a, and smoothing block 335-a, peak detection block 240-a, and impairment detection block 245-a that are similar to like blocks corresponding to test device 300-b. Frequency domain windowing block 320-a, however, is associated with a second type of impairment and thus a second window. However, the frequency domain windowing block 320-a applies the asynchronous windowing function with a second asynchronous window that is different from the first asynchronous window when transmitting a SELT signal S₁₁ (e.g., received frequency response data) to generate frequency domain data for converting into the time domain and performing further analysis thereon. The second asynchronous window is customized for detecting line cuts.

If no bridge tap was detected in a prior analysis of the impairment detection block 245-a and there is a single peak, then the single peak is chosen as the line-cut peak. If there are multiple peaks, then an empirical decision is made by the impairment detection block 245-a based at least in part on location and relative peak levels. If, however, a bridge tap is present, then the peaks associated with the bridge tap are removed, and any remaining peaks are analyzed as described herein. If there are no peaks determined, then a CO termination is declared. If there is a peak determined by the impairment detection block 245-a, a polarity of the line cut peak determines if the line cut is an open or a short.

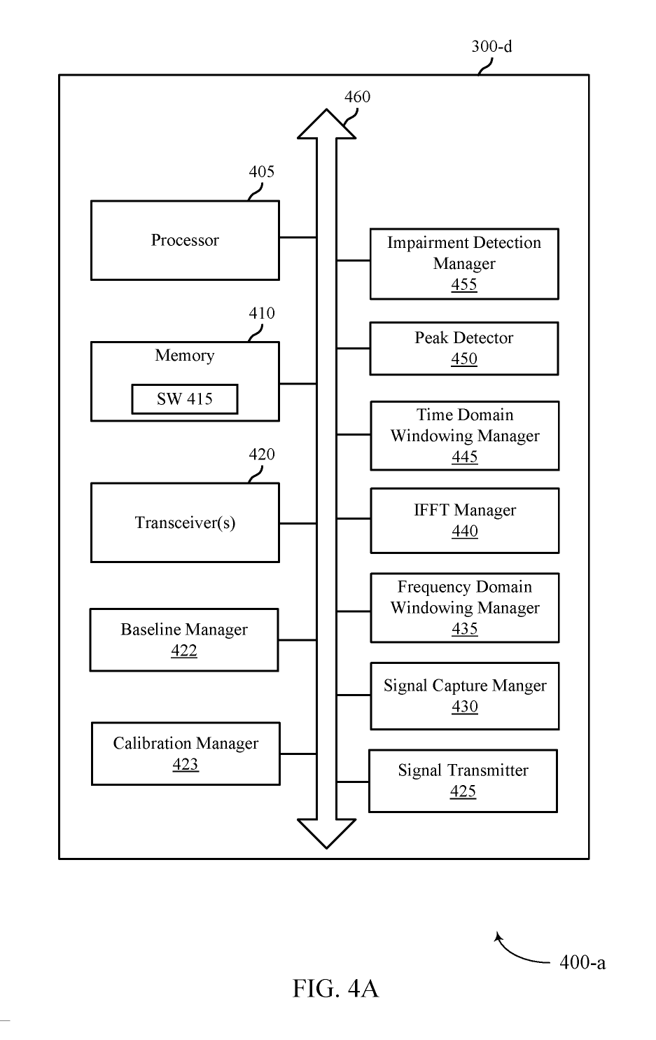

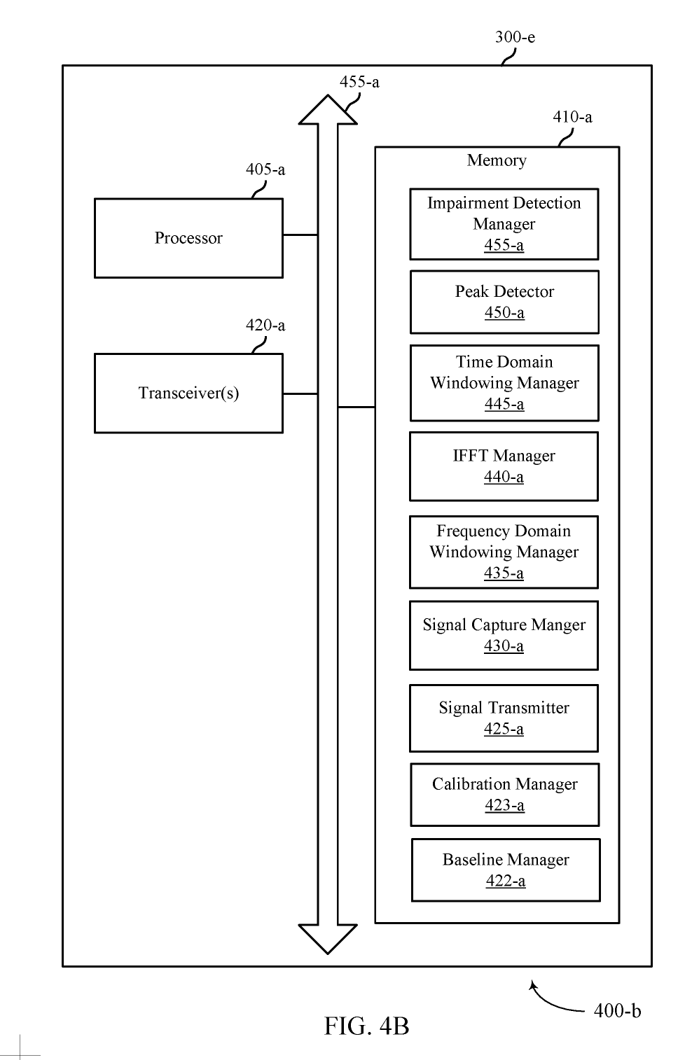

FIG. 4A shows a block diagram 400-a of an example test device 300-d that supports detecting transmission line impairments. Test device 300-d can be utilized in the DSL system 100 to test a DSL line (e.g., loop 106-1) with respect to FIG. 1 and for applying TDR techniques 202 to impairment scenario 200 described with respect to FIG. 2. Additionally, test device 300-d can include aspects of the test devices 300-a, 300-b, 300-c described with respect to FIGS. 3A-3C. Test device 300-d includes a processor 405, memory 410, one or more transceivers 420, baseline manager 422, calibration manager 423, signal transmitter 425, signal capture manager 430, frequency domain windowing manager 435, IFFT manager 440, time domain windowing manager 445, peak detector 450, and impairment detection manager 455. The processor 405, memory 410, transceiver(s) 420, baseline manager 422, calibration manager 423, signal transmitter 425, signal capture manager 430, frequency domain windowing manager 435, IFFT manager 440, time domain windowing manager 445, peak detector 450, and impairment detection manager 455 are communicatively coupled with a bus 460, which enables communication between these components. In some examples (e.g., remote testing systems), one or more links of the test device 300-d are communicatively coupled with the transceiver(s) 420.

The processor 405 is an intelligent hardware device, such as a central processing unit (CPU), a microcontroller, an application-specific integrated circuit (ASIC), etc. The memory 410 stores computer-readable, computer-executable software (SW) code 415 containing instructions that, when executed, cause the processor 405 or another one of the components of the test device 300-d to perform various functions described herein, for example, to detect transmission line impairments.

The baseline manager 422, calibration manager 423, signal transmitter 425, signal capture manager 430, frequency domain windowing manager 435, IFFT manager 440, time domain windowing manager 445, peak detector 450, and impairment detection manager 455 implement the features described with reference to FIGS. 1-3C, as further explained below.

Again, FIG. 4A shows only one possible implementation of a test device executing the features of FIGS. 1-3C. While the components of FIG. 4A are shown as discrete hardware blocks (e.g., ASICs, field programmable gate arrays (FPGAs), semi-custom integrated circuits, etc.) for purposes of clarity, it will be understood that each of the components may also be implemented by multiple hardware blocks adapted to execute some or all of the applicable features in hardware. Alternatively, features of two or more of the components of FIG. 4A may be implemented by a single, consolidated hardware block. For example, a single transceiver 420 chip or the like may implement the processor 405, baseline manager 422, calibration manager 423, signal transmitter 425, signal capture manager 430, frequency domain windowing manager 435, IFFT manager 440, time domain windowing manager 445, peak detector 450, and impairment detection manager 455.

In still other examples, the features of each component may be implemented, in whole or in part, with instructions embodied in a memory, formatted to be executed by one or more general or application-specific processors. For example, FIG. 4B shows a block diagram 400-b of another example of a test device 300-e in which the features of the baseline manager 422-a, calibration manager 423-a, signal transmitter 425-a, signal capture manager 430-a, frequency domain windowing manager 435-a, IFFT manager 440-a, time domain windowing manager 445-a, peak detector 450-a, and impairment detection manager 455-a are implemented as computer-readable code stored on memory 410-a and executed by one or more processors 405-a. Other combinations of hardware/software may be used to perform the features of one or more of the components of FIGS. 4A and 4B.

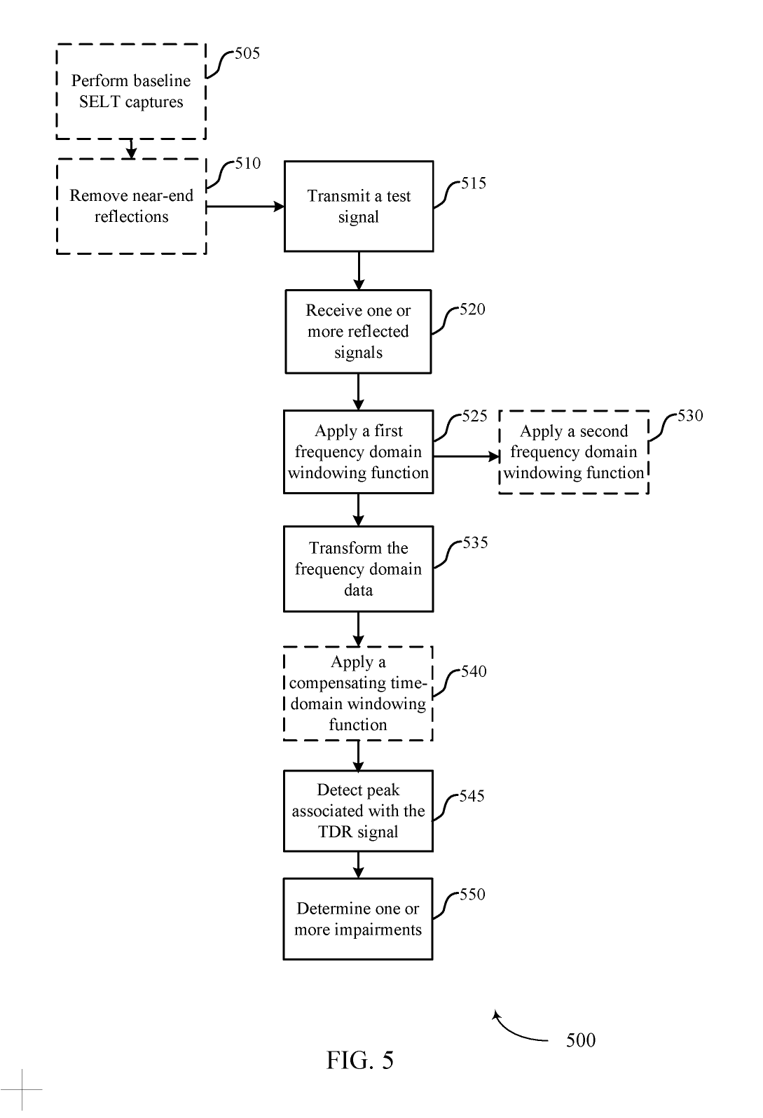

FIG. 5 shows a flow chart that illustrates an example method 500 for detecting transmission line impairments in accordance with various aspects of the present disclosure. Method 500 may be performed by any of the test devices discussed in the present disclosure, but for clarity method 500 will be described from the perspective of test device 300-d of FIG. 4A. It is to be understood that method 500 is just one example of techniques for detecting transmission line impairments, and the operations of method 500 may be rearranged, performed by other devices and component thereof, and/or otherwise modified such that other implementations are possible.

Broadly speaking, method 500 illustrates a procedure by which test device 300-d transmits a test signal on a transmission line and uses one or more reflected signals to detect impairments on the transmission line. As described herein, method 500 may be performed in association with a DSL system, but is not limited as such.

In one option, at block 505, the baseline manager 422 of the test device 300-d performs SELT captures associated with baseline tests for the transmission line. The baseline manager 422 employs other components of test device 300-d (e.g., signal transmitter 425 and transceiver(s) 420) to facilitate the repeated SELT captures associated with the baselining tests. The repeated SELT captures may be performed prior to transmitting the test signal that will be used for detecting impairments on the transmission line.

In some cases, baseline manager 422 determines, based at least in part on an output of the SELT captures, an inconsistency associated with time delay variations in a transceiver chain. In some cases, baseline manager 422 determines, based at least in part on an output of the SELT captures, that transceiver transfer function characteristics are not flat, and the baseline manager 422 adjusts, based at least in part on the determining that transceiver transfer function characteristics are not flat, a parameter setting associated with an analog/digital component block. The baselining tests are performed offline and are specified to validate the modem for SELT. Additionally, these baselining tests provide information for further calibration operations associated with the test device 300-d.

In one option, at block 510, the calibration manager 423 of the test device 300-d determines a near-end reflection signal component. When the test device 300-d transmits the test signal that will be used for detecting impairments on the transmission line, the near-end reflection signal component is removed from one or more reflected signals received in response to the transmitted test signal.

At block 515, the signal transmitter 425 of the test device 300-d transmits a test signal on the transmission line. In some cases, the signal transmitter 425 transmits a SELT signal that is a wideband signal in the frequency and time domain. In some cases, the test signal is an OFDM symbol of pseudo-random data that is repeated for several symbol periods.

At block 520, the signal capture manager 430 of the test device 300-d receives one or more reflected signals in response to the transmitted test signal. The signal capture manager 430 also coverts the one or more reflected signals into frequency response data (e.g., S₁₁ data or UER data). This frequency response data can be further modified for use in detecting impairments by the test device 300-d.

At block 525, the frequency domain windowing manager 435 of the test device 300-d applies a first asymmetric windowing function to the frequency response data (i.e., response data derived at least in part from the received one or more reflected signals) to generate frequency domain data. The first asymmetric windowing function includes a first asymmetric window that has a low frequency roll-off rate that is different from a high frequency roll-off rate. This first asymmetric window is customized to enhance the frequency signatures of the specific type of impairment to be detected.

In this regard, the first asymmetric windowing function is based at least in part an impairment detection type (e.g., a particular type of impairment or a particular frequency range for an impairment that is to be detected by the test device 300-d). Thus, the first asymmetric windowing function can be associated with the detection of a first type of impairment (e.g., a bridge tap).

In one option, at block 530, the frequency domain windowing manager 435 of the test device 300-d applies a second asymmetric windowing function to the frequency response data (i.e., response data derived at least in part from the received one or more reflected signals) to generate additional frequency domain data. The additional frequency domain data associated with the second asymmetrical windowing function is based at least in part on the same frequency response data used to generate the frequency domain data associated with the first asymmetric windowing function.

The second asymmetric windowing function, however, has a different window shape than the first asymmetric windowing function. For example, the second asymmetric windowing function includes a second asymmetric window that has a high frequency roll-off rate that is different from the high frequency roll-off rate of the first asymmetric window. This second asymmetric window is likewise customized to enhance the frequency signatures of the specific type of impairment to be detected. As such, the second asymmetric windowing function can be associated with the detection of a second type of impairment (e.g., a line cut or line card termination) that is different from the first type of impairment.

In another option, the frequency domain windowing manager 435 of the test device 300-d applies a smoothing filter to the frequency domain data associated with the first asymmetric windowing function and/or the additional frequency domain data associated with the second asymmetrical windowing function.

At block 535, the IFFT manager 440 of the test device 300-d transforms the frequency domain data to a TDR signal. In some cases, the IFFT manager 440 applies a zero-padding to the frequency domain data and performs an IFFT function on the zero-padded frequency domain data to generate the TDR signal. In this manner, the IFFT manager 440 can use a 32K IFFT function even when a number of samples associated with the frequency response data (and the frequency-domain altered frequency domain data) is less than 4K. Thus, location resolution and detection of signal peaks of the TDR signal are improved by interpolating the frequency domain data during the frequency domain to time domain transform process. Additionally, in some cases, the IFFT function is modified to provide 32-bit accuracy with 64-bit accumulation. As such, the TDR signal is more accurately represented in the time domain and the integrity of the peaks are maintained for analysis on the TDR signal.

In one option, at block 540, the time domain windowing manager 445 of the test device 300-d applies a compensating time-domain windowing function to the TDR signal. In some cases, the compensating time-domain windowing function is based at least in part on a frequency-dependent attenuation constant associated with the transmission line. The amplitude and phase characteristics of the propagation constant associated with the transmission line change with frequency. This change with frequency can cause dispersion of signal and introduce spurious artifacts in the frequency response data (e.g., data associated with or derived from SELT signal S₁₁). The propagation constant γ can be expressed as follows:

γ(f)=α(f)+jβ(f)

where α(f) is the attenuation constant and β(f) is the phase constant.

In some cases, the frequency-dependent attenuation constant has a much larger effect on the TDR analysis and therefore is compensated for by the time domain windowing manager 445 by applying the compensating time-domain windowing function to the TDR signal. Thus, a peak associated with an impairment that is located 10 feet from the DSL modem will have approximately the same level as a similar impairment that is located 1,000 feet from the DSL modem. In some cases, a first compensating time-domain window is used for detection analysis with respect to a first impairment type (e.g., a bridge tap), and a second compensating time-domain window (different from the first compensating time-domain window) is used for detection analysis with respect to a second impairment type (e.g., a line cut). Additionally or alternatively, the test device 300-d further compensates for the frequency-dependent attenuation constant by accounting for the frequency-dependent attenuation constant in peak detection and location mapping functions.

At block 545, the peak detector 450 of the test device 300-d detects peaks of the TDR signal and saves information about the detected peaks. For example, the peak levels (or amplitudes) and peak locations. It is to be understood, that when a peak is detected, the time index of the peak is proportional to the location of the impairment on the transmission line. In this manner, information associated with one or more peaks detected with respect to identifying a bridge tap on the transmission line can be removed when performing analysis for determining whether a second impairment (e.g., a line cut) also exists on the transmission line.

At block 550, the impairment detection manager 455 of the test device 300-d determines whether an impairment exists on the transmission line. This determination is based at least in part on a level of a single peak of the TDR signal (e.g., if a single legitimate peak is detected, then a line card is present on the transmission line, but if no legitimate peak is detected, then the transmission line is clear). In some cases, the impairment detection manager 455 detects a particular type of impairment on the transmission line based at least in part on a ratio of two or more peak levels of the TDR signal (e.g., a bridge tap and location of the bridge tap on the transmission line using the ratio). In other cases, the impairment detection manager 455 detects a particular type of impairment on the transmission line based at least in part on a distance between two peaks of the TDR signal (e.g., a bridge tap and a length of the bridge tap using the distance between the two peaks).

In other cases, the impairment detection manager 455 detects a particular type of impairment on the transmission line based at least in part on an absolute amplitude of a peak of the TDR signal and a polarity of the peak (e.g., a termination condition determined as an open or short based at least in part on the polarity of the peak). In yet other cases, the impairment detection manager 455 removes one or more peaks associated with a first impairment type (e.g., two peaks associated with a bridge tap) detected on the transmission line, and detects a remaining peak associated with a second impairment type (e.g., a remaining legitimate peak associated with a line cut, a line card, or a termination condition) on the transmission line based at least in part on an absolute level of a peak of the TDR signal. In this regard, the time domain signatures of various types of impairments can be accurately determined using the information concerning the various detected peaks.

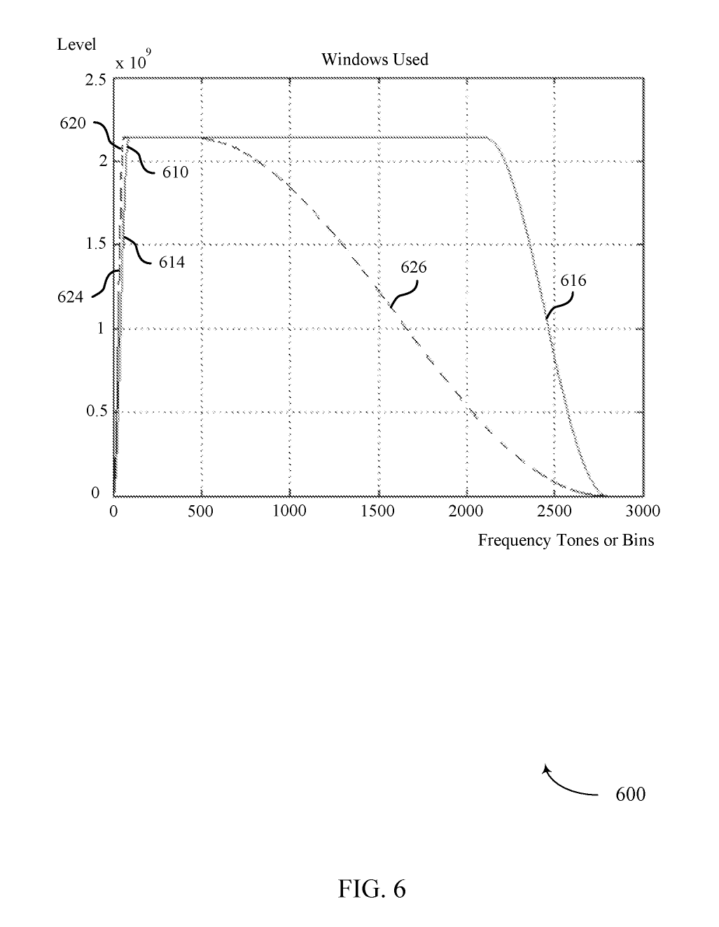

FIG. 6 is a plot 600 illustrating examples of different asymmetric windows used for frequency domain windowing functions described herein. These asymmetric windows are customized for particular impairments (e.g., a line cut or bridge tap) such that the frequency domain signatures of the particular impairment are enhanced. Asymmetric window shapes can be chosen based on resolution, dynamic range, and sensitivity. Additionally, the shape of the roll-off for each of the asymmetric window is determined based at least in part on a shape of the signature of the particular impairment type to minimize or reduce secondary peaks from over-shoot. In plot 600 of FIG. 6, the x-axis identifies frequency tones or bins and the y-axis represent level. In some cases, 2,800 tones can span a 12 MHz bandwidth, with each tone approximately 4.285 kHz.

For example, asymmetric window 620 (dashed line) includes a shorter or sharper roll-off region 624 at lower frequencies than the longer or more gradual roll-off region 626 at higher frequencies. That is, asymmetric window 620 results in higher frequencies experiencing higher attenuation than lower frequencies. Thus, for asymmetric window 620, lower frequencies have a larger part of the signature in a reflected signal. In some cases, asymmetric window 620 is used for detecting a line cut on the transmission line.

That is, asymmetric window 620 is shaped to maximize, increase, or emphasize the frequency domain signatures associated with a line cut. After optional smoothing, the peak of the absolute values may be detected. In this regard, only peaks that are above a predetermined threshold are to be analyzed. For example, if a bridge tap was not detected in a prior analysis of transmission line impairments, and there is a single peak identified in the analysis using asymmetric window 620, this single peak is identified as a line cut peak.

Asymmetric window 610 (solid line) includes a short or sharp roll-off region 614 at low frequencies and a long or gradual roll-off region 616 at high frequencies. However, the short or sharp roll-off region 614 of asymmetric window 610 is different from the short or sharper roll-off region 624 of asymmetric window 620, and the long or gradual roll-off region 616 of asymmetric window 610 is different from the long or gradual roll-off region 626 of asymmetric window 620. In some cases, asymmetric window 610 is used for detecting a bridge tap on the transmission line. That is, asymmetric window 610 is shaped to maximize, increase, or emphasize the frequency domain signatures associated with a bridge tap.

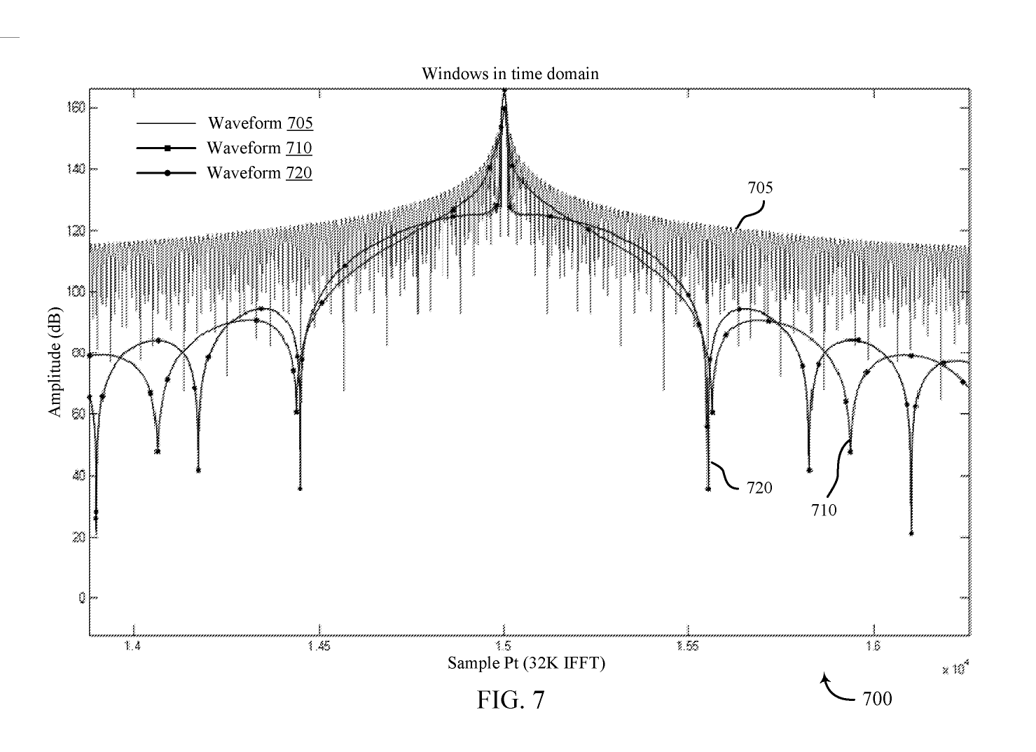

FIG. 7 is a plot 700 illustrating example time domain representations of different frequency domain windows used for frequency domain windowing functions described herein. Waveform 705 is the time domain representation of a rectangular frequency domain window (e.g., after performing an IFFT on the rectangular frequency domain window). In some implementations where asynchronous frequency domain windows are not used, a rectangular frequency domain window may be used for frequency domain windowing functions. Waveform 710 is the time domain representation of asymmetric window 610 with respect to FIG. 6 (e.g., after performing an IFFT on the rectangular frequency domain window), and waveform 720 is the time domain representation of asymmetric window 620 with respect to FIG. 6 (e.g., after performing an IFFT on the rectangular frequency domain window).

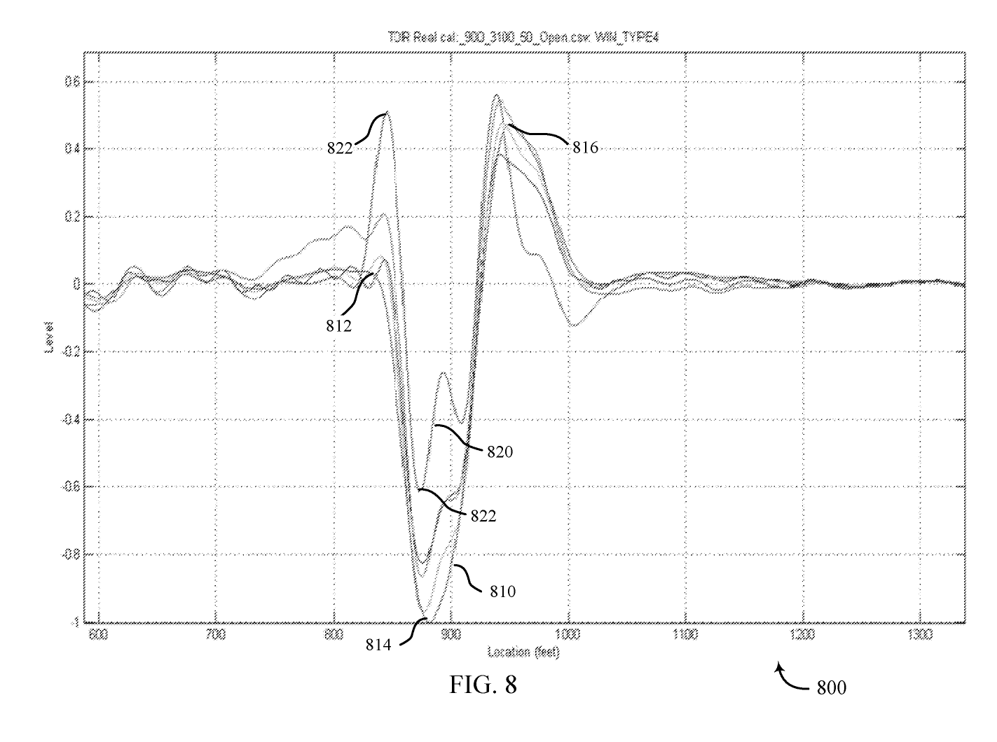

FIG. 8 is a plot 800 illustrating examples of the effects of different windows used for windowing functions. Each of the traces is associated with the same bridge tap impairment on a DSL line that is approximately 700 feet from the DSL modem. Proper signature of a bridge tap is a negative peak followed by a positive peak. Trace 810 exhibits a clean and detectable signature of the bridge tap with no (or negligible) over-shoot 812 prior to the prominent negative peak 814. Trace 810 also exhibits a prominent positive peak 816. Frequency domain windowing functions and time domain windowing functions customized for bridge tap impairments as described herein were used in generating trace 810.

By contrast, trace 820 exhibits a detection error prone signature of the bridge tap with considerable over-shoot 822 prior to an attenuated negative peak 824. The over-shoot 822 could lead to a false positive by misidentifying the over-shoot 822 as a positive peak. The attenuated negative peak 824 could lead to a determination that this peak is a spurious spike as opposed to a legitimate peak. The remaining traces on plot 800 are example traces that include at least one or more of the techniques for detecting transmission line impairments described herein. While not as accurate as trace 810, each of the remaining traces would likely result in a correct determination of a bridge tap. Each of the remaining traces, however, would likely not provide as accurate of an impairment determination result (e.g., location of the bridge tap and length of the bridge tap) as trace 810.

FIG. 9 is a plot 900 illustrating examples of a detected and located transmission line impairment. Trace 910 exhibits clean and detectable signatures of a bridge tap impairment that is approximately 500 feet and an open line cut at approximately 2,200 feet from the DSL modem on a DSL line. Spurious peaks 912 can be noticed below 500 feet as some of the windowing and smoothing functions described herein were not performed during trace 910.

The detailed description set forth above in connection with the appended drawings describes examples and does not represent the only examples that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

Information and signals may be represented using any of a variety of different technologies and techniques. For example, data, instructions, commands, information, signals, bits, and symbols that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these.

Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein, but is to be accorded the broadest scope consistent with the principles and novel features disclosed herein.

What is claimed is:

1. A method for detecting one or more impairments in a transmission line, the method comprising:
transmitting a test signal;
receiving one or more reflected signals in response to the test signal;
applying a first asymmetric windowing function to the one or more reflected signals to generate frequency domain data; and
transforming the frequency domain data from a frequency-domain representation to a time-domain representation to generate a time domain reflectometry (TDR) signal.

2. The method of claim 1, wherein the first asymmetric windowing function comprises a low frequency roll-off rate that is different from a high frequency roll-off rate.

3. The method of claim 1, wherein a window shape of the first asymmetric windowing function is based at least in part an impairment detection type, the impairment detection type being selected from one member of the group consisting of: a bridge tap, a line cut, and a line card termination.

4. The method of claim 1, further comprising:
applying a second asymmetric windowing function to the one or more reflected signals to generate additional frequency domain data, the second asymmetric windowing function having a different widow shape than the first asymmetric windowing function.

5. The method of claim 1, further comprising:
applying a compensating time domain windowing function to the TDR signal.

6. The method of claim 5, wherein the compensating time domain windowing function is based at least in part on a frequency-dependent attenuation constant associated with the transmission line.

7. The method of claim 1, further comprising:
applying a smoothing filter to one member of the group consisting of: the frequency domain data, and the TDR signal.

8. The method of claim 1, wherein the transforming the frequency domain data from the frequency-domain representation to the time-domain representation comprises:
zero-padding the frequency domain data; and
performing an inverse fast Fourier transform (IFFT) function on the zero-padded frequency domain data to generate the TDR signal.

9. The method of claim 1, further comprising:
determining an impairment on the transmission line based at least in part on a level of a peak of the TDR signal.

10. The method of claim 1, further comprising:
determining an impairment on the transmission line based at least in part on a ratio of two or more peak levels of the TDR signal.

11. The method of claim 1, further comprising:
determining an impairment on the transmission line based at least in part on a distance between two or more peaks of the TDR signal.

12. The method of claim 1, further comprising:
performing, prior to transmitting the test signal, a plurality of Single Ended Line Test (SELT) captures for the transmission line.

13. The method of claim 12, further comprising:
determining, based at least in part on an output of the plurality of SELT captures, an inconsistency associated with time delay variations in a transceiver chain.

14. The method of claim 12, further comprising:
determining, based at least in part on an output of the plurality of SELT captures, that transceiver transfer function characteristics are not flat; and
adjusting, based at least in part on the determining that transceiver transfer function characteristics are not flat, a parameter setting associated with an analog/digital component block.

15. The method of claim 1, further comprising:
removing a near-end reflection signal component from the received one or more reflected signals.

16. A device for detecting one or more impairments on a transmission line, the device comprising:
a signal transmitter to transmit a test signal;
a signal capture manager to receive one or more reflected signals in response to the transmitted test signal and to convert the one or more reflected signals into frequency response data;
a frequency domain windowing manager to apply a first asymmetric windowing function to the frequency response data to generate frequency domain data; and
an inverse fast Fourier transform (IFFT) manager to transform the frequency domain data to a time domain reflectometry (TDR) signal.

17. The device of claim 16, wherein the first asymmetric windowing function comprises a low frequency roll-off rate that is different from a high frequency roll-off rate.

18. The device of claim 16, wherein a window shape of the first asymmetric windowing function is based at least in part an impairment detection type, the impairment detection type being selected from one member of the group consisting of: a bridge tap, a line cut, and a line card termination.

19. The device of claim 16, wherein the frequency domain windowing manager is further to apply a second asymmetric windowing function to the one or more reflected signals to generate additional frequency domain data, the second asymmetric windowing function having a different widow shape than the first asymmetric windowing function.

20. The device of claim 16, further comprising:
a time domain windowing manager to apply a compensating time domain windowing function to the TDR signal.

21. The device of claim 16, wherein the IFFT manager is further to apply a zero-padding to the frequency domain data and perform an IFFT function on the zero-padded frequency domain data to generate the TDR signal.

22. The device of claim 16, further comprising:
an impairment detection manager to determine an impairment on the transmission line based at least in part on a level of a peak of the TDR signal.

23. The device of claim 16, further comprising:
a baseline manager to perform a plurality of Single Ended Line Test (SELT) captures for the transmission line.

24. The device of claim 16, further comprising:
a calibration manager to remove a near-end reflection signal component from the received one or more reflected signals.

25. A device for detecting one or more impairments on a transmission line, the device comprising:
means for transmitting a test signal;
means for receiving one or more reflected signals in response to the test signal;
means for applying a first asymmetric windowing function to the one or more reflected signals to generate frequency domain data; and
means for transforming the frequency domain data from a frequency-domain representation to a time-domain representation to generate a time domain reflectometry (TDR) signal.

26. The device of claim 25, wherein the first asymmetric windowing function comprises a low frequency roll-off rate that is different from a high frequency roll-off rate.

27. The device of claim 25, wherein a window shape of the first asymmetric windowing function is based at least in part an impairment detection type, the impairment detection type being selected from one member of the group consisting of: a bridge tap, a line cut, and a line card termination.

28. The device of claim 25, further comprising:
means for applying a second asymmetric windowing function to the one or more reflected signals to generate additional frequency domain data, the second asymmetric windowing function having a different widow shape than the first asymmetric windowing function.

29. The device of claim 25, further comprising:
means for applying a compensating time domain windowing function to the TDR signal.

30. A non-transitory computer-readable medium comprising computer-readable code that, when executed, causes a device to:
transmit a test signal;
receive one or more reflected signals in response to the test signal;
apply a first asymmetric windowing function to the one or more reflected signals to generate frequency domain data; and
transform the frequency domain data from a frequency-domain representation to a time-domain representation to generate a time domain reflectometry (TDR) signal.
